(19) United States
(12) Patent Application Publication
(10) Pub. No.: US 2026/0370070 A1
(43) Pub. Date: Nov. 19, 2026

(54) Axial Flux Electric Machine with Circumferentially Magnetised Rotor and Magnetic Flux Guiding Structures

(71) Applicant: Tohid Asefi, Cambridge (GB)

(72) Inventor: Tohid Asefi, Cambridge (GB)

(21) Appl. No.: 19/702,870

(22) Filed: Jun. 9, 2026

(51) Int. Cl. H02K 1/24; H02K 1/14; H02K 1/2796; H02K 1/2798; H02K 21/24

(52) U.S. Cl. CPC H02K 1/246; H02K 1/146; H02K 1/2796; H02K 1/2798; H02K 21/24; H02K 2201/12

(57) ABSTRACT

An axial flux electric machine comprising at least one stator assembly and at least one rotor assembly separated by one or more air gaps is disclosed. The rotor assembly comprises a plurality of permanent magnets arranged about an axis of rotation and magnetized substantially in a circumferential direction relative thereto. Magnetic segments positioned between adjacent permanent magnets cooperate with the permanent magnets to establish magnetic flux-guiding structures and controlled magnetic flux paths within the machine. The magnetic segments influence magnetic flux distribution, magnetic saliency, and air-gap magnetic field characteristics and may establish a substantially sinusoidal or quasi-sinusoidal air-gap flux density distribution. The resulting magnetic architecture may reduce harmonic content, improve electromagnetic performance, and contribute to reluctance torque production in addition to permanent-magnet synchronous torque. The disclosed concepts may be implemented in dual-stator single-rotor, dual-rotor single-stator, and other axial flux machine topologies operating as electric motors, generators, or motor-generator systems.

### FIELD OF THE INVENTION

The present invention relates generally to electric machines and electromagnetic energy conversion devices. More particularly, the invention relates to axial flux electric machines employing circumferentially magnetized permanent magnets and magnetic flux guiding structures configured to influence magnetic flux distribution, torque production, and electromagnetic performance.

In various embodiments, the disclosed technology may be applied to electric motors, electrical generators, motor-generator systems, integrated starter-generators, traction machines, aerospace propulsion systems, industrial drive systems, renewable energy systems, and other rotary electromagnetic energy conversion devices utilizing axial flux machine architectures.

### BACKGROUND OF THE INVENTION

Axial flux electric machines have attracted significant interest in recent years due to their potential for high torque density, compact axial dimensions, and efficient electromagnetic energy conversion. Such machines are utilized in a wide range of applications including electric vehicles, industrial drives, aerospace propulsion systems, renewable energy generation systems, and integrated motor-generator assemblies.

Conventional axial flux machines generally comprise one or more stator assemblies and one or more rotor assemblies arranged such that magnetic flux is directed substantially parallel to the axis of rotation. Various machine topologies have been proposed, including single-rotor single-stator configurations, dual-stator single-rotor configurations, and dual-rotor single-stator configurations. Permanent magnet axial flux machines are particularly attractive due to their high efficiency and power density characteristics.

Many conventional axial flux permanent magnet machines employ permanent magnets that are magnetized substantially in an axial direction. While such arrangements have demonstrated acceptable performance in numerous applications, they may present limitations associated with magnetic flux control, air-gap flux density distribution, harmonic content, torque ripple, and utilization of available magnetic material. In addition, conventional machine architectures may rely predominantly upon permanent-magnet torque production and may not fully exploit magnetic saliency effects that can contribute additional reluctance torque.

Various techniques have been proposed to modify magnetic flux distribution within electric machines. However, many existing approaches require increased structural complexity, additional magnetic components, specialized manufacturing processes, or machine geometries that may limit design flexibility and scalability. Furthermore, existing axial flux machine architectures may not provide optimal control of magnetic flux paths while simultaneously supporting multiple machine topologies and torque production mechanisms.

Accordingly, there remains a need for improved axial flux electric machine architectures capable of providing enhanced magnetic flux control, improved air-gap flux density distribution, increased torque density, reduced harmonic content, and combined permanent-magnet and reluctance torque production while maintaining flexibility across a variety of axial flux machine configurations.

### SUMMARY OF THE INVENTION

The present invention provides an axial flux electric machine architecture employing circumferentially magnetized permanent magnets and magnetic flux guiding structures configured to influence magnetic flux distribution, torque production, and overall electromagnetic performance.

According to various embodiments, an axial flux electric machine comprises at least one stator assembly and at least one rotor assembly separated by one or more air gaps. The rotor assembly includes a plurality of permanent magnets arranged with a circumferential magnetization orientation relative to an axis of rotation of the machine. Magnetic flux generated by the permanent magnets traverses the air gap and interacts with the stator assembly to produce electromagnetic torque and/or electrical power.

In certain embodiments, magnetic segments are positioned between adjacent permanent magnets. The magnetic segments may comprise magnetic flux-guiding bodies configured to guide, concentrate, redirect, shape, or otherwise influence magnetic flux within the machine. The magnetic segments may further establish magnetic saliency within the rotor assembly, thereby enabling the production of a reluctance torque component in addition to permanent-magnet synchronous torque.

In various embodiments, the magnetic segments cooperate with the circumferentially magnetized permanent magnets to establish controlled magnetic flux paths and to modify the spatial distribution of magnetic flux within the air gap. Such arrangements may improve air-gap flux density characteristics, reduce harmonic content, improve torque production, improve efficiency, and enhance overall machine performance. In certain embodiments, the resulting air-gap magnetic flux density distribution may be substantially sinusoidal.

The disclosed concepts may be implemented in a variety of axial flux machine topologies. In some embodiments, the machine comprises a dual-stator, single-rotor configuration in which a rotor assembly is positioned between first and second stator assemblies. In other embodiments, the machine comprises a dual-rotor, single-stator configuration in which a stator assembly is positioned between first and second rotor assemblies. Additional axial flux machine configurations utilizing the disclosed magnetic arrangements are also contemplated.

The stator assemblies may comprise laminated magnetic structures including stator teeth, stator slots, stator cores, and stator back-yoke regions configured to support electrical windings. The electrical windings may comprise concentrated windings, distributed windings, or combinations thereof. Various conductor geometries may be utilized, including round conductors, hollow round conductors, flat conductors, and hollow flat conductors.

The disclosed machine may operate as an electric motor, an electrical generator, or a combined motor-generator system. The disclosed architecture is therefore applicable to a broad range of industrial, transportation, aerospace, renewable energy, and electromagnetic energy conversion applications.

The foregoing summary is provided to introduce representative aspects of the invention and is not intended to identify every embodiment, feature, or limitation of the disclosed subject matter. Additional features and advantages will become apparent from the following detailed description and accompanying drawings.

### BRIEF DESCRIPTION OF THE DRAWINGS

FIG. 1A illustrates a dual-stator single-rotor axial flux machine.

FIG. 1B illustrates a dual-rotor single-stator axial flux machine.

FIG. 2 illustrates a magnetic architecture including circumferentially magnetized permanent magnets and magnetic segments.

FIG. 3 illustrates a first electromagnetic embodiment.

FIG. 4 illustrates a second electromagnetic embodiment.

FIG. 5 illustrates a third electromagnetic embodiment.

FIG. 6 illustrates a three-dimensional dual-stator machine embodiment.

FIG. 7 illustrates a three-dimensional dual-rotor machine embodiment.

FIG. 8 illustrates a laminated stator magnetic structure.

FIG. 9 illustrates an exemplary air-gap flux density distribution.

### DETAILED DESCRIPTION OF THE PREFERRED EMBODIMENTS

### Definitions

The following description is provided to enable a person skilled in the art to make and use the disclosed invention. Various modifications, alternatives, equivalents, and combinations of the described embodiments may be employed without departing from the scope of the invention as defined by the appended claims.

As used herein, the term “axial flux electric machine” refers to an electric motor, electrical generator, motor-generator system, or other electromagnetic energy conversion device in which magnetic flux is directed substantially parallel to an axis of rotation.

As used herein, the term “circumferentially magnetized permanent magnet” refers to a permanent magnet having a magnetization vector extending substantially along a circumferential direction relative to an axis of rotation of the machine.

As used herein, the term “magnetic segment” refers to a body positioned between adjacent permanent magnets of a rotor assembly and configured to influence magnetic flux distribution within the machine. The magnetic segment may comprise a material, structure, or combination thereof having magnetic properties different from those of an adjacent non-magnetic region and configured to guide, concentrate, redirect, shape, conduct, or otherwise influence magnetic flux.

In various embodiments, the magnetic segment may exhibit a magnetic permeability, relative permeability, permeance, reluctance, magnetic conductivity, or combinations thereof selected to influence magnetic flux paths, magnetic saliency, air-gap flux density distribution, harmonic content, reluctance torque production, or combinations thereof.

The magnetic segment may comprise a homogeneous structure, a laminated structure, a composite structure, or combinations thereof. Exemplary materials include ferromagnetic materials, laminated electrical steels, soft magnetic composites, ferrites, powdered magnetic materials, and combinations thereof.

As used herein, the term “magnetic flux guiding structure” refers to any arrangement of permanent magnets, magnetic segments, magnetic materials, or combinations thereof configured to influence magnetic flux distribution within the machine.

As used herein, the term “rotor assembly” refers to a rotating assembly comprising one or more permanent magnets and associated magnetic structures configured to rotate about an axis of rotation.

As used herein, the term “stator assembly” refers to a stationary electromagnetic assembly comprising magnetic material and one or more electrical windings configured to interact electromagnetically with a rotor assembly.

Reference will now be made in detail to exemplary embodiments of the invention, examples of which are illustrated in the accompanying drawings.

### Machine Topologies

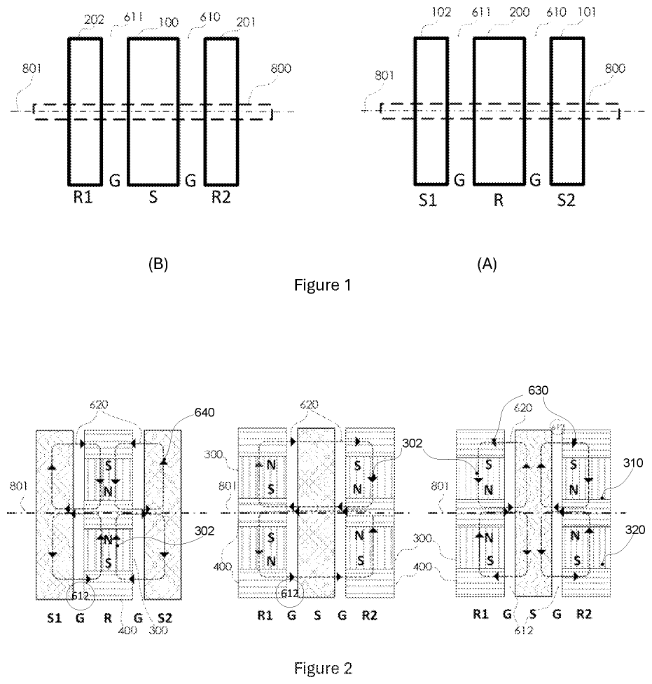

Referring to FIG. 1, exemplary axial flux electric machine topologies according to various embodiments of the invention are illustrated.

FIG. 1A illustrates a dual-stator single-rotor arrangement comprising a first stator assembly (101), a rotor assembly (200), and a second stator assembly (102). A first air gap (610) is provided between the first stator assembly (101) and the rotor assembly (200), and a second air gap (611) is provided between the second stator assembly (102) and the rotor assembly (200). Electromagnetic interaction between the rotor assembly and the stator assemblies occurs across the respective air gaps.

FIG. 1B illustrates a dual-rotor single-stator arrangement comprising a first rotor assembly (201), a stator assembly (100), and a second rotor assembly (202). A first air gap (610) is provided between the first rotor assembly (201) and the stator assembly (100), and a second air gap (611) is provided between the second rotor assembly (202) and the stator assembly (100). Electromagnetic interaction between the rotor assemblies and the stator assembly occurs across the respective air gaps.

In various embodiments, the stator assemblies comprise electrical windings and magnetic structures configured to interact with magnetic fields generated by the rotor assemblies. The rotor assemblies may comprise circumferentially magnetized permanent magnets and magnetic segments configured to establish magnetic flux paths through the machine.

Although dual-stator and dual-rotor embodiments are illustrated, the invention is not limited to the configurations shown. The disclosed magnetic architectures may be implemented in single-rotor, multi-rotor, single-stator, multi-stator, or other axial flux machine arrangements without departing from the scope of the invention.

The machine may operate as an electric motor, an electrical generator, or a combined motor-generator system. The disclosed architecture is applicable to a wide range of power ratings, operating speeds, and application environments.

### Magnetic Architecture and Flux Paths

Referring to FIG. 2, exemplary magnetic architectures and magnetic flux paths according to various embodiments of the invention are illustrated.

The rotor assembly (200) comprises a plurality of permanent magnets (300) arranged about an axis of rotation (801). Unlike conventional axial flux machines employing axially magnetized permanent magnets, the permanent magnets (300) are circumferentially magnetized such that the magnetization direction (302) extends substantially along a circumferential direction relative to the axis of rotation.

Magnetic segments (400) are positioned between adjacent permanent magnets (300). The magnetic segments (400) cooperate with the permanent magnets (300) to establish magnetic flux paths (620) extending through the rotor assembly and across the air-gap region (612). In various embodiments, the magnetic segments (400) influence the direction, concentration, distribution, and continuity of magnetic flux within the machine.

Magnetic flux generated by the permanent magnets (300) traverses the air gaps (610, 611) and interacts with the stator assemblies (100, 101, 102). The resulting electromagnetic interaction produces torque when the machine operates as a motor and electrical power when the machine operates as a generator.

In certain embodiments, the magnetic segments (400) establish magnetic saliency within the rotor assembly (200). The resulting saliency may influence local magnetic reluctance and may contribute to the production of a reluctance torque component in addition to permanent-magnet synchronous torque. Accordingly, the disclosed architecture may combine characteristics of permanent-magnet machines and reluctance machines within a single axial flux topology.

The magnetic segments (400) may comprise magnetic flux guiding structures configured to guide magnetic flux between adjacent magnetic poles (310, 320). In various embodiments, the magnetic segments may modify the spatial distribution of magnetic flux within the air-gap region (612), influence harmonic content, and contribute to establishment of a desired air-gap flux density distribution.

The geometry, dimensions, quantity, spacing, and arrangement of the permanent magnets (300) and magnetic segments (400) may vary according to the requirements of a particular application. Similarly, the magnetic segments may comprise homogeneous, laminated, composite, or other magnetic structures configured to provide desired magnetic characteristics.

Although specific magnetic flux paths (620), rotor flux paths (630) and stator flux paths (640) are illustrated, such flux paths are exemplary only. The precise flux distribution may vary according to machine geometry, material properties, operating conditions, winding configuration, and other design parameters while remaining within the scope of the invention.

### Electromagnetic Embodiments, Phase Arrangements, and Conductor Configurations

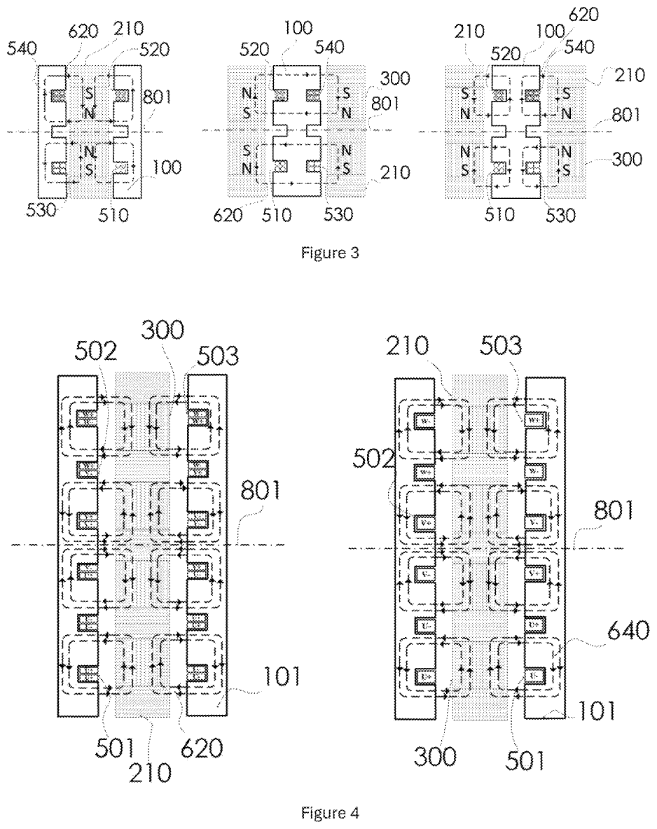

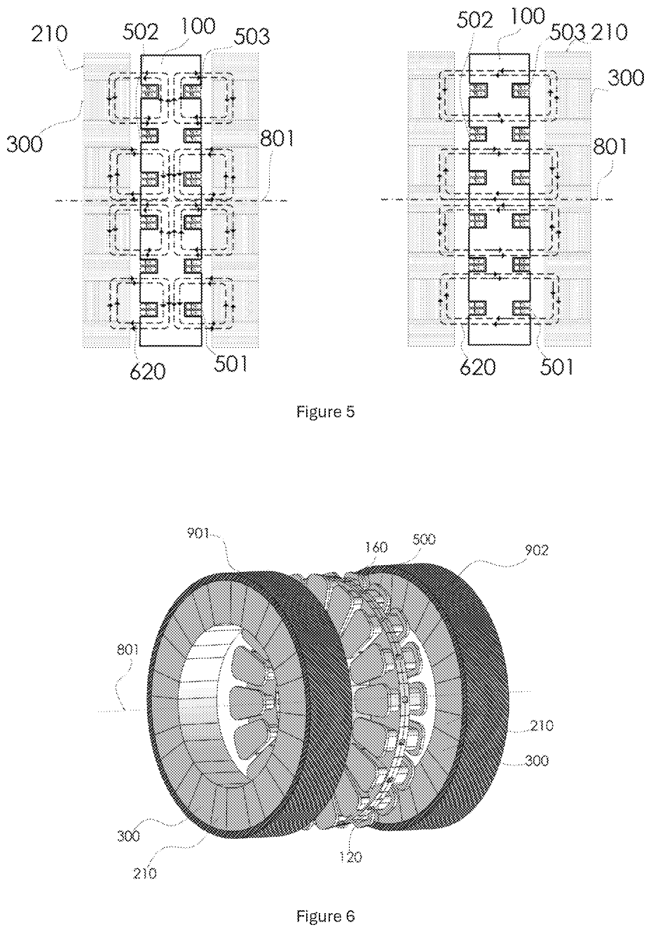

Referring to FIGS. 3, 4, and 5, various electromagnetic embodiments of the invention are illustrated. The illustrated embodiments demonstrate representative combinations of circumferentially magnetized permanent magnets (300), magnetic segments (210), stator structures (100, 101), phase coils (501, 502, 503), conductor configurations (510, 520, 530, 540), and magnetic flux paths (620).

The phase coils may include a U-phase coil (501), a V-phase coil (502), and a W-phase coil (503) in a three-phase embodiment. In other embodiments, the machine may comprise a five-phase winding arrangement, a multi-phase winding arrangement, a dual three-phase winding arrangement, a multi-three-phase winding arrangement, or combinations thereof. In various embodiments, the electrical conductors forming the phase coils may comprise round conductors (510), hollow round conductors (520), flat conductors (530), hollow flat conductors (540), or combinations thereof. Hollow conductor embodiments may include internal cooling passages (541) configured to permit circulation of a cooling medium.

The conductor and phase arrangements may be implemented as concentrated windings, distributed windings, fractional-slot windings, integral-slot windings, or combinations thereof. The winding arrangement may be selected according to torque density, efficiency, thermal performance, manufacturability, cooling requirements, fault tolerance, phase redundancy, or combinations thereof.

The magnetic segments (210) cooperate with the permanent magnets (300) to establish magnetic flux paths (620) and influence magnetic flux distribution within the machine. Depending upon the embodiment, the magnetic segments may contribute to magnetic saliency, flux concentration, harmonic reduction, reluctance torque production, or combinations thereof.

The embodiments illustrated in FIGS. 3, 4, and 5 are representative examples and should not be interpreted as limiting the invention to any particular phase count, conductor geometry, winding topology, magnetic arrangement, or electromagnetic configuration.

### 3D Machine Magnetics Embodiments

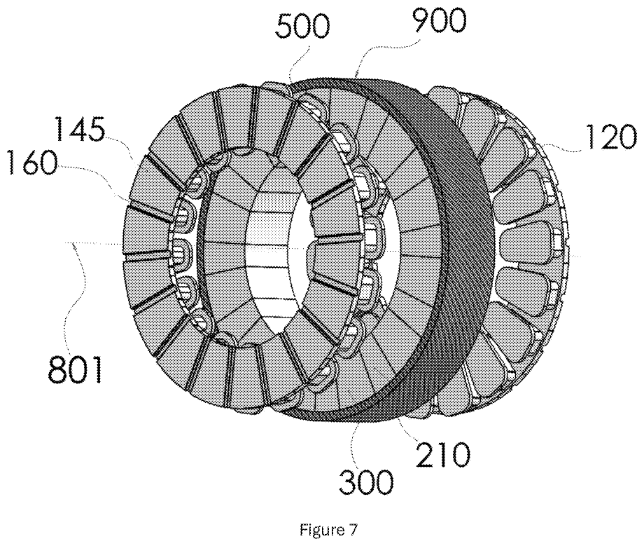

Referring to FIGS. 6 and 7, exemplary 3D embodiments of axial flux electric machines according to the invention are illustrated.

The illustrated embodiments comprise one or more stator assemblies (100, 101) and one or more rotor assemblies carrying permanent magnets (300) and magnetic segments (210) arranged about an axis of rotation (801). The stator assemblies may comprise stator teeth (120), stator slot regions (160), stator back-yoke regions (145), electrical windings (500), and associated magnetic structures.

The rotor assemblies may further comprise one or more retaining structures (900, 901, 902) configured to mechanically retain the permanent magnets (300) and magnetic segments (210) during operation. In certain embodiments, the retaining structures may comprise fibre-reinforced composite structures, carbon-fibre-reinforced composite structures, metallic retaining structures, or combinations thereof.

FIGS. 6 and 7 demonstrate exemplary three-dimensional arrangements of stator structures, rotor structures, magnetic segments, permanent magnets, and winding assemblies. The illustrated embodiments are representative only and are not intended to limit the invention to any particular structural geometry, dimensional relationship, assembly arrangement, or manufacturing technique.

The structural embodiments shown in FIGS. 6 and 7 may be implemented in dual-stator single-rotor configurations, dual-rotor single-stator configurations, or other axial flux machine topologies while retaining the magnetic and electromagnetic principles described herein.

### Laminated Magnetic Structures

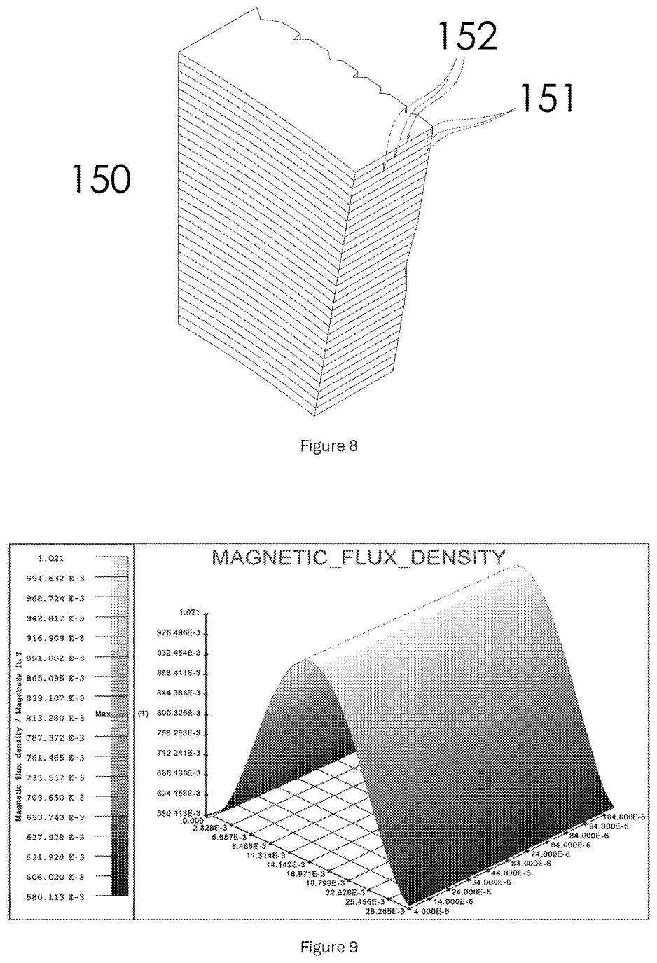

Referring to FIG. 8, an exemplary laminated magnetic structure according to an embodiment of the invention is illustrated.

The stator assembly (100) may comprise a laminated magnetic structure configured to guide magnetic flux while reducing eddy-current losses. In the illustrated embodiment, the stator assembly includes a stator tooth lamination stack (150) formed from a plurality of individual lamination layers (151) separated by lamination insulation layers (152).

The lamination layers (151) may comprise electrical steel, silicon steel, cobalt-iron alloys, nickel-iron alloys, amorphous magnetic materials, nanocrystalline magnetic materials, or other magnetic materials suitable for electric machine applications. The lamination insulation layers (152) electrically isolate adjacent lamination layers and thereby reduce circulating eddy currents generated by time-varying magnetic fields.

The stator tooth lamination stack (150) may be arranged along a lamination stack axis (153) to form a stacked lamination assembly. The resulting structure may provide a magnetic flux path while minimizing core losses and maintaining desirable magnetic permeability characteristics.

In various embodiments, the stator assembly (100) further comprises stator teeth (120), stator slots (110), stator cores (130), and stator back-yoke regions (145) configured to support electrical windings (500) and guide magnetic flux generated by the rotor assembly (200).

The laminated magnetic structures may be configured according to desired electromagnetic performance, manufacturing requirements, mechanical constraints, thermal considerations, or combinations thereof. The number of lamination layers, lamination thickness, insulation thickness, material selection, and stacking arrangement may vary according to the requirements of a particular application.

Although FIG. 8 illustrates a particular laminated stator structure, the invention is not limited to the specific embodiment shown. Alternative lamination geometries, stacking arrangements, magnetic materials, insulation systems, and manufacturing techniques may be employed without departing from the scope of the invention.

### Air-gap Flux Density Distribution

Referring to FIG. 9, an exemplary air-gap flux density distribution according to an embodiment of the invention is illustrated.

The illustrated air-gap flux density distribution is generated through cooperation between the circumferentially magnetized permanent magnets (300) and the magnetic segments (400) positioned between adjacent permanent magnets. The magnetic segments influence magnetic flux paths within the rotor assembly (200) and contribute to shaping the magnetic field distribution established across the air-gap region (612).

In various embodiments, the magnetic segments (400) cooperate with the permanent magnets (300) to establish controlled magnetic flux paths (620) and to influence the spatial distribution of magnetic flux density within the air-gap region. The resulting magnetic field distribution may differ substantially from that produced by conventional axial flux machine architectures employing axially magnetized permanent magnets without magnetic flux-guiding structures.

In certain embodiments, the resulting air-gap flux density distribution may be substantially sinusoidal. A substantially sinusoidal air-gap flux density distribution may contribute to reduced harmonic content, reduced torque ripple, improved electromagnetic performance, improved efficiency, enhanced controllability, and increased torque production.

The magnetic segments (400) may further influence magnetic saliency within the rotor assembly (200), thereby contributing to reluctance torque production in addition to permanent-magnet synchronous torque production. Consequently, the disclosed magnetic architecture may provide combined torque-producing mechanisms within an axial flux machine.

The air-gap flux density distribution illustrated in FIG. 9 is representative of one embodiment of the invention and is not intended to limit the scope of the disclosed subject matter. The precise shape, amplitude, harmonic content, and spatial distribution of the air-gap magnetic flux density may vary according to machine dimensions, magnet geometry, magnetic material properties, magnetic segment configuration, winding arrangement, operating conditions, and other design parameters.

In various embodiments, the disclosed magnetic architecture may be configured to establish sinusoidal, substantially sinusoidal, quasi-sinusoidal, trapezoidal, or other desired air-gap magnetic flux density distributions according to the requirements of a particular application.

The embodiments described herein are presented for purposes of illustration and description and are not intended to limit the invention to the precise forms disclosed. Numerous modifications, substitutions, and variations may be made without departing from the spirit and scope of the invention as defined by the appended claims.

1. An axial flux electric machine comprising: at least one stator assembly; at least one rotor assembly arranged adjacent the stator assembly and separated therefrom by at least one air gap; a plurality of permanent magnets disposed on the rotor assembly; and a plurality of magnetic segments positioned between adjacent permanent magnets; wherein the permanent magnets are circumferentially magnetized with respect to an axis of rotation of the machine; and wherein the permanent magnets and the magnetic segments cooperate to establish magnetic flux paths traversing the at least one air gap and interacting with the at least one stator assembly.

2. The axial flux electric machine of claim 1, wherein the magnetic segments influence magnetic flux distribution, establish magnetic saliency within the rotor assembly, and contribute to generation of a reluctance torque component in addition to permanent-magnet synchronous torque.

3. The axial flux electric machine of claim 1, wherein the permanent magnets and magnetic segments cooperate to establish magnetic flux-guiding structures configured to modify an air-gap flux density distribution that is substantially sinusoidal or quasi-sinusoidal.

4. The axial flux electric machine of claim 1, wherein the machine comprises a dual-stator single-rotor configuration or a dual-rotor single-stator configuration.

5. The axial flux electric machine of claim 1, wherein the stator assembly comprises electrical windings disposed within stator slots, the electrical windings comprising concentrated windings, distributed windings, round conductors, hollow round conductors, flat conductors, hollow flat conductors, or combinations thereof.

6. A rotor assembly for an axial flux electric machine comprising: a plurality of permanent magnets arranged about an axis of rotation; and a plurality of magnetic segments positioned between adjacent permanent magnets; wherein the permanent magnets are circumferentially magnetized with respect to the axis of rotation; and wherein the magnetic segments cooperate with the permanent magnets to establish magnetic flux paths configured to interact with a stator assembly of the axial flux electric machine.

7. The rotor assembly of claim 6, wherein the magnetic segments establish magnetic saliency and contribute to generation of a reluctance torque component when operated within an axial flux electric machine.

8. The rotor assembly of claim 6, wherein the magnetic segments cooperate with the permanent magnets to modify an air-gap flux density distribution that is substantially sinusoidal or quasi-sinusoidal.

9. The rotor assembly of claim 6, wherein the permanent magnets and magnetic segments cooperate to generate both permanent-magnet torque and reluctance torque when operated within an axial flux electric machine.

10. A magnetic flux-guiding structure for an axial flux electric machine comprising: a plurality of circumferentially magnetized permanent magnets arranged about an axis of rotation; and a plurality of magnetic segments positioned between adjacent permanent magnets; wherein the magnetic segments cooperate with the permanent magnets to establish magnetic flux paths configured to traverse an air gap of the axial flux electric machine.

11. The magnetic flux-guiding structure of claim 10, wherein the magnetic segments modify a spatial distribution of magnetic flux within the air gap of the axial flux electric machine and reduce harmonic content of an air-gap magnetic flux density waveform relative to a machine employing circumferentially magnetized permanent magnets without magnetic segments positioned between adjacent permanent magnets.

12. The magnetic flux-guiding structure of claim 10, wherein the magnetic segments and permanent magnets cooperate to establish a substantially sinusoidal or quasi-sinusoidal air-gap flux density distribution and contribute to generation of a reluctance torque component.

13. The axial flux electric machine of claim 1, wherein the magnetic segments comprise a homogeneous structure, a laminated structure, a composite structure, or combinations thereof, and comprise a material selected from ferromagnetic materials, laminated electrical steels, soft magnetic composites, ferrites, powdered magnetic materials, or combinations thereof.

14. The axial flux electric machine of claim 1, wherein the magnetic segments are configured to influence magnetic permeability, permeance, magnetic reluctance, magnetic conductivity, or combinations thereof within the rotor assembly.

15. The axial flux electric machine of claim 1, wherein the magnetic segments are configured to smooth magnetic transitions between adjacent magnetic poles.

16. The axial flux electric machine of claim 1, wherein the magnetic segments cooperate with the permanent magnets to improve magnetic flux uniformity across the air-gap region.

17. The axial flux electric machine of claim 1, wherein the stator assembly comprises a laminated magnetic structure including a plurality of lamination layers separated by electrically insulating layers.

18. The axial flux electric machine of claim 17, wherein the laminated magnetic structure comprises a stator tooth lamination stack configured to guide magnetic flux between the stator assembly and the rotor assembly.

19. The axial flux electric machine of claim 1, wherein the machine is configured to operate as an electric motor, an electrical generator, or a motor-generator system.

20. The rotor assembly of claim 6, further comprising a fibre-reinforced composite retaining structure surrounding at least a portion of the permanent magnets and the magnetic segments, the fibre-reinforced composite retaining structure being configured to provide mechanical retention of the permanent magnets during rotation about the axis of rotation.
